(19) United States
(12) Patent Application Publication
(10) Pub. No.: US 2026/0288624 A1
(43) Pub. Date: Sep. 24, 2026

(54) TEST CODE GENERATION SYSTEM AND TEST CODE GENERATION METHOD

(71) Applicant: Hitachi, Ltd., Tokyo (JP)

(72) Inventors: Darshan CHAWDA, Tokyo (JP); Yosuke HIMURA, Tokyo (JP); Hitoshi YABUSAKI, Tokyo (JP)

(21) Appl. No.: 19/305,494

(22) Filed: Aug. 20, 2025

(30) Foreign Application Priority Data
Mar. 21, 2025 (JP) 2025-047470

(51) Int. Cl. G06F 11/3668

(52) U.S. Cl. CPC G06F 11/3684; G06F 11/3688

(57) ABSTRACT

A computer executes each of the test codes, and outputs one or more logs, with respect to the corresponding test code, and acquires one or more feature vectors from the one or more logs of each of the test codes. The computer classifies the test codes into a plurality of clusters, based on the one or more feature vectors acquired from the one or more logs of each of the test codes. The computer generates a generalized test code from the one or more test codes constituting each test code set in each of the clusters.

### CROSS-REFERENCE TO PRIOR APPLICATION

This application relates to and claims the benefit of priority from Japanese Patent Application number 2025-047470, filed on Mar. 21, 2025 the entire disclosure of which is incorporated herein by reference.

### BACKGROUND

The present invention generally relates to test code generation.

Businesses have been adopting various cloud-based architectures. In cloud-based systems, applications where various services and components are integrated (e.g., cloud computing services) are implemented. The technology disclosed in US2010/0229155A1 manually creates a test case for a test target application, selects a test script from a library, and associates the selected test script with the test case.

### SUMMARY

US2010/0229155A1 requires manual customization of the test script selected from the library and associated with the test target application in accordance with the test target application. That is, with respect to each application, a test script dedicated for the application is required.

Such a problem is particularly significant in a case where the test target application is a cloud-based application. This is because the cloud-based application has dynamic and scalable characteristics. Specifically, as follows. A plurality of applications serving as services independent from each other are deployed in a common infrastructure on which a cloud system (cloud-based system) is based, and these applications can be managed as a single project. These applications are often updated, scaled, or reconfigured. Accordingly, if there are many manual interventions for a test for the applications, the update, scaling, or reconfiguration is performed, and manual operations are required every time of testing, and the load is high. In the cloud system, many applications are sometimes deployed. If dedicated test scripts are prepared respectively for the many applications, redundant test scripts (e.g., heavily redundant test scripts) may be prepared.

A computer executes each of the test codes, and outputs one or more logs, with respect to the corresponding test code, and acquires one or more feature vectors from the one or more logs of each of the test codes. The computer classifies the test codes into a plurality of clusters, based on the one or more feature vectors acquired from the one or more logs of each of the test codes. The computer generates a generalized test code from the one or more test codes constituting each test code set in each of the clusters.

According to the present invention, the test script for the cloud-based system can be prevented from being redundant, and manual intervention can be reduced when the test script is applied. Problems, configurations, and advantageous effects other than those described above are clarified by the following description of embodiments.

### BRIEF DESCRIPTION OF THE DRAWINGS

FIG. 1 shows a configuration of an entire system that includes a test code generation system according to an embodiment;

FIG. 2 shows an overview of the embodiment;

FIG. 3 shows processes performed by the test code generation system;

FIG. 4 schematically shows a configuration of mapping data;

FIG. 5 shows the details of the flow of processes of code generalization;

FIG. 6 shows an example of test-related data;

FIG. 7 shows an example of similarity determination data;

FIG. 8 shows an example of cluster classification data; and

FIG. 9 shows an example of a code template.

### DETAILED DESCRIPTION

In the following description, “interface apparatus” may be one or more interface devices. The one or more interface devices may be any of one or more I/O (Input/Output) interface devices and one or more communication interface devices. The I/O (Input/Output) interface device is an interface device for at least one between the I/O device and a remote display computer. The I/O interface device for the display computer may be a communication interface device. At least one I/O device may be a user interface device, for example, any one of an input device such as a keyboard and a pointing device, and an output device such as a display device. One or more communication interface devices may be one or more communication interface devices of the same type (e.g., one or more NICs (Network Interface Cards)), or two or more communication interface devices of different types (e.g., an NIC and an HBA (Host Bus Adapter)).

In the following description, “memory” is one or more memory devices, and typically, a main storage device. At least one memory device in the memory may be a volatile memory device, or a nonvolatile memory device.

In the following description, “persistent storage apparatus” is one or more persistent storage devices. Typically, the persistent storage device is a nonvolatile storage device (e.g., auxiliary storage device), and specifically, for example, an HDD (Hard Disk Drive) or an SSD (Solid State Drive).

In the following description, “storage apparatus” may be at least the memory selected from the memory and the persistent storage apparatus.

In the following description, “processor” is one or more processor devices. Typically, at least one processor device may be a microprocessor device such as a CPU (Central Processing Unit), but may be another type of processor device such as a GPU (Graphics Processing Unit). At least one processor device may be a single core or multi-core one. At least one processor device may be a processor core. At least one processor device may be a processor device in a broad sense, such as a hardware circuit (e.g., an FPGA (Field-Programmable Gate Array) or an ASIC (Application Specific Integrated Circuit)) that performs part or the entire process.

In the following description, a function is sometimes described with representation of “vvv module”. The function may be implemented by execution of one or more computer programs by a processor, implemented by one or more hardware circuits (e.g., an FPGA or an ASIC), or implemented by a combination of them. In the case where the function is implemented by the program being executed by the processor, a predetermined process is performed using the storage apparatus, the interface apparatus and/or the like as appropriate. Accordingly, the function may be regarded as at least part of the processor. A process described using a function as a subject may be a process that the processor or an apparatus including the processor performs. The program may be installed from a program source. The program source may be, for example, a program distributing computer or a computer-readable recording medium (e.g., a nontransitory recording medium). Description of each function is an example, and a plurality of functions may be integrated into one function, or one function may be divided into a plurality of functions.

In the following description, in a case of description without distinction between elements of the same type, common symbols among reference symbols are sometimes used, and in a case of description with distinction between elements of the same type, the reference symbols are sometimes used.

Referring to the diagrams, an embodiment of the present invention is described below. Note that in the following description, terms that are “test case”, “test code”, and “test script” are distinguished as follows. That is, the “test case” corresponds to a test scenario, and is a set of conditions designed to verify whether specific characteristics and functions of the application allow an intended operation, inputs or expected results. The “test code” is data as representation of the test case in a programming language. The test code includes code for executing steps defined in the test case. The test code interacts with the test target application, and the expected operation is automatically verified. The “test script” is a set of test codes (one or more test codes) that can be comprehensively executed to automate test processes (all or some of steps among steps defied in the test case).

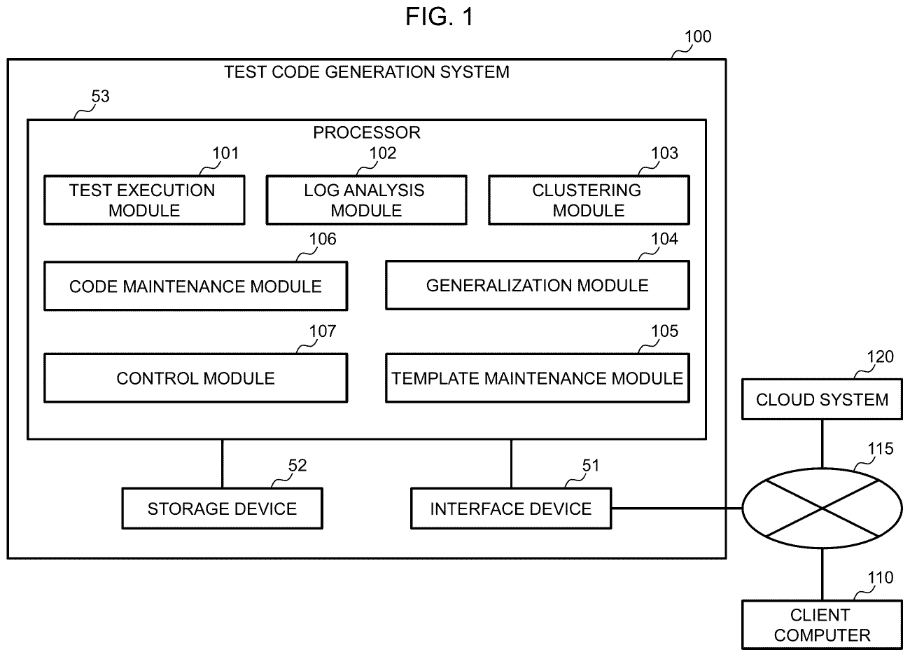

FIG. 1 shows a configuration of an entire system that includes a test code generation system according to an embodiment.

A test code generation system 100 is coupled to a communication network 115. The test code generation system 100 is coupled to the communication network 115, to which a client computer 110 and a cloud system 120 are coupled.

The communication network 115 may be any network, such as the Internet, a WAN (Wide Area Network), or a VPN (Virtual Private Network).

The client computer 110 is a client for the test code generation system 100 as a server. The client computer 110 may be an information processing terminal, such as a personal computer or a smartphone. The client computer 110 may be what is called an input/output console (user interface device) for the test code generation system 100.

The cloud system 120 is a cloud-based system, and is a system in which an application (application program) is implemented.

The test code generation system 100 is a physical computer system made up of one or more physical computers, but may be a logical computer system based on a physical computer system. For example, this system may be a system that is implemented in the cloud system 120 and serves as a cloud computing service.

The test code generation system 100 includes an interface apparatus 51, a storage apparatus 52, and a processor 53 coupled to these apparatuses 51 and 52.

The interface apparatus 51 is, for example, an NIC (Network Interface Card), and communicates via the communication network 115.

The storage apparatus 52 stores data and programs. The data to be stored includes, for example, test codes, logs, mapping data, and code templates, as described later.

The program is executed by the processor 53, which achieves functions of a text execution module 101, a log analysis module 102, a clustering module 103, a generalization module 104, a template maintenance module 105, a code maintenance module 106, and a control module 107. These modules 101 to 107 can communicate with each other.

The text execution module 101 executes the test code, and generates an API log, an access log, and other logs, for each executed test code. These logs serve as input data for processes in the system 100.

The log analysis module 102 analyzes the logs (logs for each executed test code) generated by the text execution module 101, and extracts test-related data that is data including data usable to form feature vectors, from these logs. Specifically, for example, related data includes data with respect to each of prescribed data items, such as a resource type, a fault type, and a test scenario. The feature vectors are formed based on the test-related data.

The clustering module 103 classifies the executed test codes into a plurality of clusters using the feature vectors formed by the log analysis module 102. The clustering module 103 assures that these clusters are created based on a meaningful constraint, and efficient test management is promoted.

The generalization module 104 uses the clusters formed by the clustering module 103, and predefined code templates to generalize the clusters on a cluster-by-cluster basis. The generalized cluster is a generalized test script.

The template maintenance module 105 manages the code templates used by the generalization module 104. For example, the template maintenance module 105 maintains the code templates to the latest code templates.

The code maintenance module 106 adds, changes, or removes the test codes in the system 100. While the addition, change, or removal of the test codes can affect test codes in the clusters (or clusters related to the clusters including the test codes) that include the test codes, the code maintenance module 106 can maintain the test codes that can be affected by the addition, change, or removal of the test codes.

The control module 107 executes processes other than the processes performed by the modules 101 to 106.

The test code generation system 100 automates a series of processes that includes execution of test codes, analysis of logs, clustering of test codes, and generation of generalized test codes. Accordingly, effective and scalable test management in the cloud system 120 are realized. The test code generation system 100 reduces manual operations, increases test code reusability, and improves applicability of the test processes to a dynamic cloud environment.

The system configuration is not necessarily limited to the configuration shown in FIG. 1. For example, instead of the client computer 110, user interface devices such as an input device and a display device may be coupled to the interface apparatus 51 of the test code generation system 100 and thus be provided.

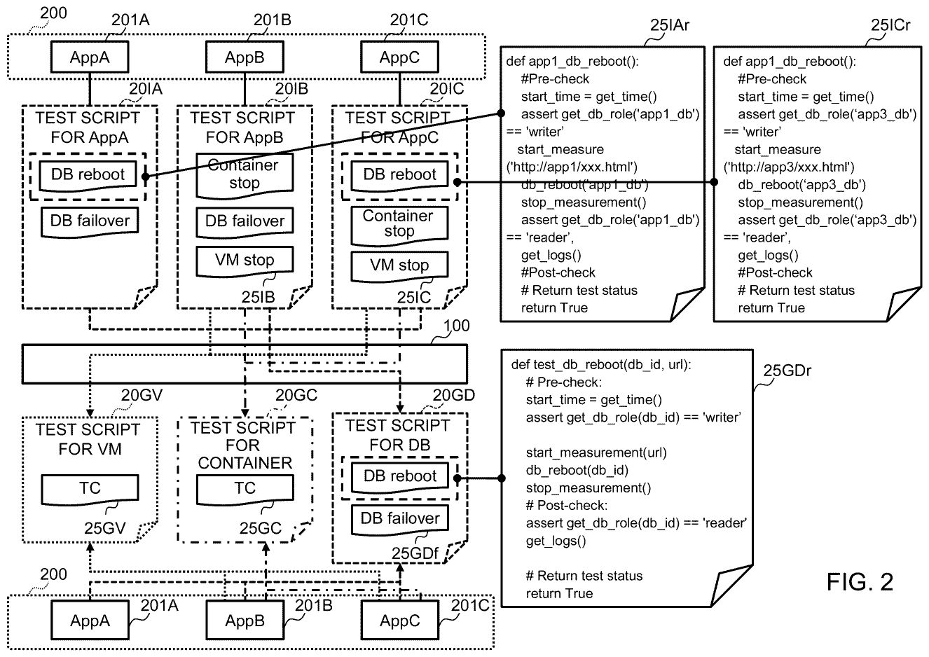

FIG. 2 shows an overview of the embodiment. Note that in FIG. 2, “TC” is an abbreviation for the test code.

In this embodiment, as described later, by the test code generation system 100, generalized test scripts 20G each made up of one or more generalized test codes 25G are constructed, and the generalized test scripts 20G are assigned to applications 201. These generalized test scripts 20G are constructed based on the test codes 25.

The applications 201 are deployed in the cloud system 120. One or more applications among the applications 201, for example, applications 201A to 201C, are sometimes managed as a single project 200. The applications 201A to 201C in the project 200 can be provided as one cloud-based service. The type of project 200 may be any type. For example, the project 200 that includes the applications 201A to 201C is a development project.

Each of the applications 201A to 201C is assumed as a test target application. That is, the test is performed on a project-by-project basis. When no generalized test script 20G is present (i.e., in the initial state), with respect to each of the applications 201A to 201C, individual test scripts 201 that are hardcoded test scripts dedicated for the corresponding application 201 are prepared. Each individual test script 201 is made up of individual test codes 25I that are one or more hardcoded test codes. Note that the individual test script 201 may be prepared not only in the initial state but also in a state where there are one or more generalized test scripts 20G but no required generalized test script 20G, for example.

Examples of the applications 201 and the individual test scripts 201 are as follows.

Each application 201 may be made up of one or more components (one or more service programs). The one or more components may include at least one of a container, a database, and a VM. The component “container” may be encapsulated in an environment from which an application component has been separated. The component “database” may be a component as what is called a database management system, save and acquire data, and secure the integrity and consistency of the entire application. The component “VM” (e.g., hypervisor) may perform generation, stop, monitoring, removal and the like of VM.

The application 201A is assumed to include the component “database”. Accordingly, an individual test script 20IA associated with the application 201A includes a test code related to the component “database” as an individual test code 25IA.

The applications 201B is assumed to include the components “database”, “container”, and “VM”. Accordingly, an individual test script 20IB associated with the application 201B includes the test code related to the component “database”, the test code related to the component “container”, and the test code related to the component “VM” as individual test codes 25IB.

The applications 201C is assumed to include the components “database”, “container”, and “VM”. Accordingly, the individual test script 20IC associated with the application 201C includes the test code related to the component “database”, the test code related to the component “container”, and the test code related to the component “VM” as individual test codes 25IC.

Here, the individual test scripts 20IA include an individual test code 25IAr related to database reboot as the individual test code 25IA related to the component “database”. Likewise, the individual test scripts 20IC include an individual test code 25ICr related to database reboot as the individual test code 25IA related to the component “database”. These individual test codes 25IAr and 25ICr in common in database reboot are almost similar to the applications 201A and 201C except specific variables. As a result, the individual test codes 25IAr and 25ICr can be called redundant test codes. As described above, when the same test is executed for different applications 201, the individual test script 201 for each application 201 includes the individual test codes 25I that is similar except a part (e.g., the variables specific to the application 201). Consequently, the individual test codes 25I redundant across the applications 201 are prepared. There are many manual interventions to prepare the individual test codes 25I.

The test code generation system 100 then generates one or more test code clusters by clustering the test codes 25, and generates generalized test codes 25G, with respect to each similar test code set in the same test code cluster, based on the similar test code set. As a result, the generalized test script 20G that includes one or more generalized test codes 25G is constructed. The “test code cluster” may be a set of test codes 25 with the same test target application component. The “similar test code set” in the test code cluster may be a set of test codes with the common test content, and is made up of one or more test codes, for example. Each of the one or more generalized test codes 25G in the generalized test script 20G is a test code generated from one or more test codes that constitute the similar test code set corresponding to the generalized test codes 25G. That is, each similar test code set in the test code cluster is replaced with the generalized test code 25G, thereby constructing the generalized test script 20G.

In the example shown in FIG. 2, a generalized test script 20GV related to the component “VM”, a generalized test script 20GC related to the component “container”, and a generalized test script 20GD related to the component “database” are constructed. The generalized test script 20GV corresponds to a test code cluster as a set of the individual test codes 25IB and 25IC related to VM stop in the individual test scripts 20IB and 20IC, and includes one generalized test code 25GV generated based on the similar test code set made up of the individual test codes 25IB and 25IC related to VM stop. The generalized test script 20GC corresponds to a test code cluster as a set of the individual test codes 25IB and 25IC related to container stop in the individual test scripts 20IB and 20IC, and includes one generalized test code 25GC generated based on the similar test code set made up of the individual test codes 25IB and 25IC related to container stop. The generalized test script 20GD corresponds to a test code cluster as a set of individual test codes 25IA to 25IC related to the component “database” in the individual test scripts 20IA to 20IC, and includes one generalized test code 25GDr generated based on the similar test code set made up of the individual test codes 25IAr and 25ICr related to database reboot, and one generalized test code 25GDf generated based on the similar test code set made up of the individual test codes 25IA and 25IB related to database failover.

With an example of database reboot, the generalized test code 25GDr is generated from the individual test codes 25IAr and 25ICr as follows. The individual test code 25IAr includes a description representing pre-check to verify whether the current role of the database is the writer, a description representing a subsequent reboot process, and a description representing post-check to check whether the role of the database has transitioned to the reader. Likewise, the individual test code 25ICr has a description having substantially identical content except a difference specific to the difference between the application 201A and the application 201C. The difference specific to these test scripts 20IAr and 25ICr (e.g., the database identifier and URL) can be abstracted into a parameter, and the generalized test code GDr that includes the abstracted parameter, and the common point between these test scripts 20IAr and 25ICr can be generated. Specifically, for example, the generalized test code 25GDr uses inputs of “db_id” and “url” to execute a series of pre-check, reboot, and post-check. This negates the need to create or manage separate test codes 25I for similar operations among the different applications 201. By adopting the single generalized test code 25G, the redundancy is removed, and the scalability and applicability of dynamic test code management in the cloud system 120 can be improved. This is also effective in removing the overhead of test code maintenance.

As described above, the generalized test script 20GV, 20GC, and 20GD are constructed. Each of the generalized test scripts 20GV, 20GC, and 20GD is associated with at least one of the applications 201A to 201C as follows. That is, the generalized test script 20GV related to the component “VM” is associated with each of the applications 201B and 201C (i.e., the applications 201B and 201C including component “VM”) assigned the individual test script 201 including the individual test codes 25I related to the component “VM”. The generalized test script 20GC related to the component “container” is associated with each of the applications 201B and 201C (i.e., the applications 201B and 201C including component “container”) assigned the individual test script 201 including the individual test codes 25I related to the component “container”. The generalized test script 20GD related to the component “database” is associated with each of the applications 201A to 201C (i.e., the applications 201A to 201C including component “database”) assigned the individual test script 20I including the individual test codes 25I related to the component “database”.

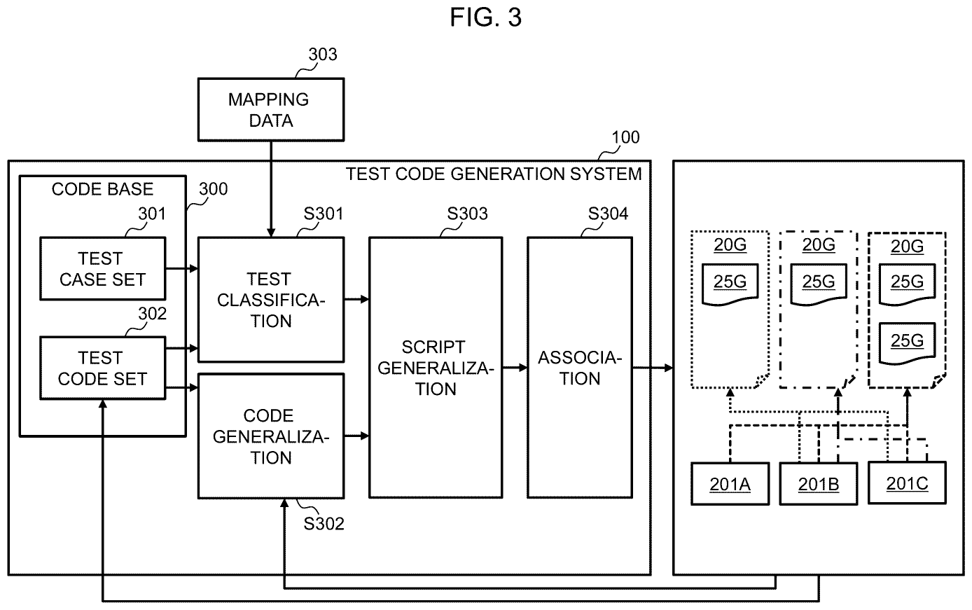

FIG. 3 shows processes performed by the test code generation system 100.

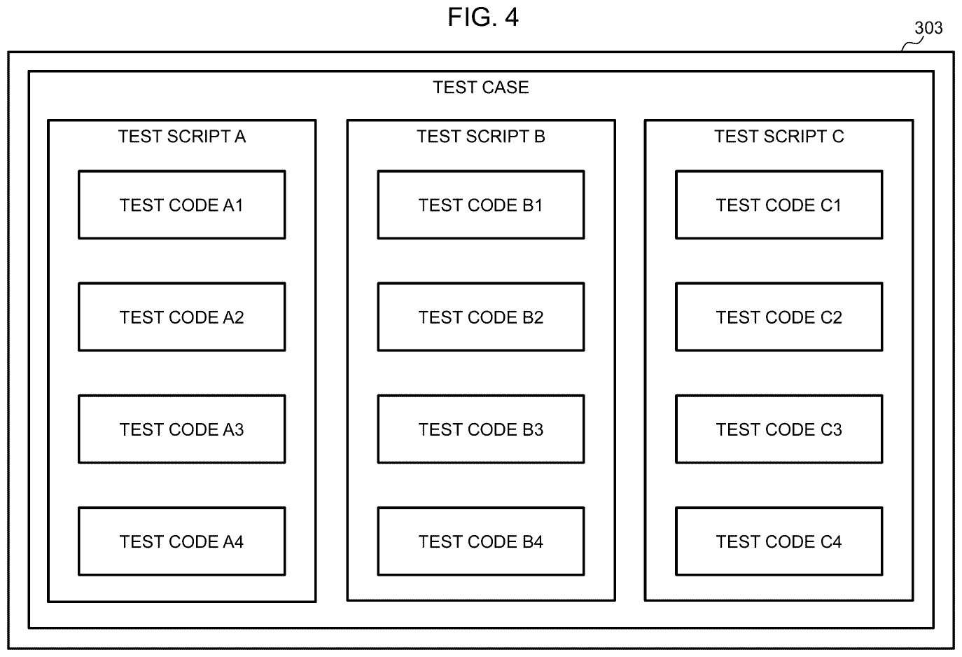

A codebase 300 including test case sets 301 and 302 is stored in the storage apparatus 52. The mapping data 303 is stored in the storage apparatus 52. The test case set 301 is a set of test cases. The test code set 302 is a set of the test codes 25. The mapping data 303 is data that represents the correspondence relationship between the test case, test script, and test code (see FIG. 4).

Test classification is performed (S301). In S301, the control module 107 classifies the one or more test codes 25 into each test case with respect to each test case such that the relationship between one or more test cases identified from the test case set 301 and one or more test codes 25 included in the test code set 302 can be the same correspondence relationship represented by the mapping data 303. That is, in S301, the test codes 25 in the test code set 302 are classified into corresponding test cases represented by the test case set 301.

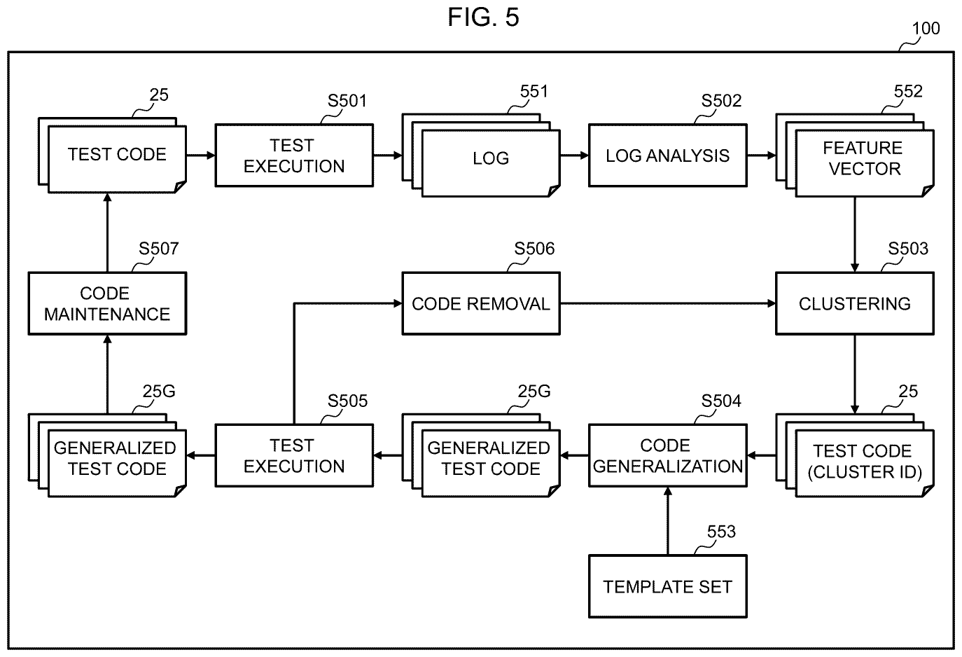

Test code generalization is performed (S302). Specifically, the similarity between test code snippets is identified, the redundancy is eliminated, and the reusable generalized test code 25G is generated. The test code generalization is described later with reference to FIG. 5.

Script generalization is performed (S303). In S303, the generalized test script 20G that includes the generalized test code 25G generated in S302 is constructed.

Association is made (S304). In S304, for each generalized test script 20G, the control module 107 associates the generalized test script 20G with one or more applications 201 including the application component corresponding to the corresponding generalized test script 20G.

Based on the result of the association, the test code cluster may be corrected in S302. For example, if the new generalized test script 20G does not function for any application 201 as the association destination, the cluster on which the generalized test script 20G is based may be corrected.

Likewise, the generalized test code 25G may be corrected. For example, if the generalized test code 25G that does not function for any application 201 as the association destination is present, the generalized test code 25G may be corrected.

FIG. 5 shows the details of the flow of processes of code generalization (S302).

The test codes 25 are test codes 25 in the test code set 302 (FIG. 3). The test codes 25 are individual test codes 25I initially, but includes the generalized test codes 25G after these generalized test codes 25G are generated. That is, the test codes 25 are made up only of the individual test codes 25I in some cases, and mixedly made up of the individual test codes 25I and the generalized test codes 25G in other cases. Eventually, the individual test codes 25I may be eliminated from the test codes 25, and a set made up only of the generalized test codes 25G may be the test codes 25.

Test execution is performed (S501). In S501, the text execution module 101 executes each test code 25 in the test code set 302. For each test code 25, in test execution, logs 551, such as an API log and an access log, are generated and output by the text execution module 101. These logs 551 is used as raw data in analysis for generating the test code cluster.

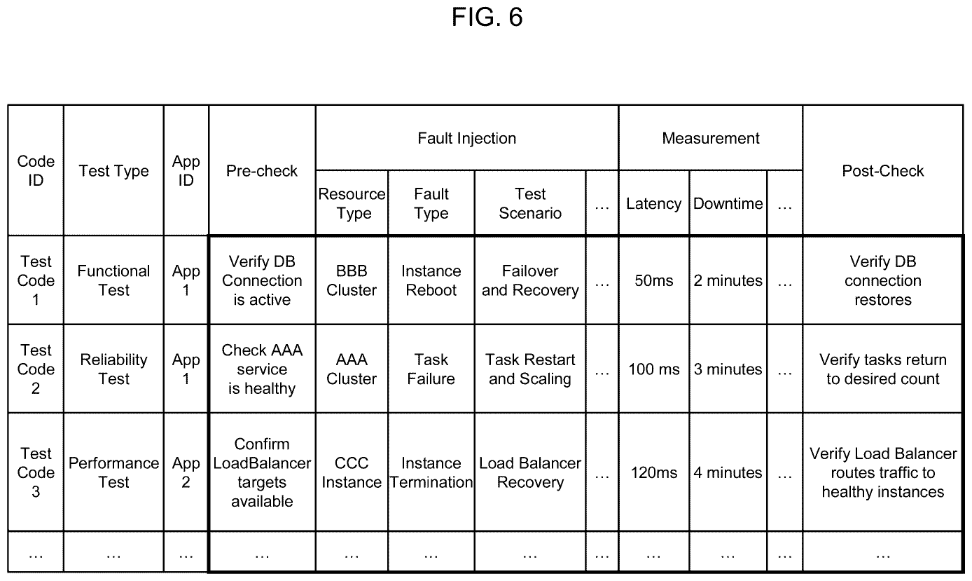

Log analysis is performed (S502). In S502, the log analysis module 102 analyzes the logs 551 of the executed test codes 25, extracts data required for test-related data from the logs 551, and the test-related data is constructed using the extracted data. FIG. 6 shows an example of the test-related data. The test-related data includes records for the respective executed test codes 25. For each test code 25, the record includes information, such as on the code ID, test type, AppID, pre-check, fault injection, measurement, and post-check. The “code ID” represents the ID of the test code 25. The “test type” represents the type of the test performed by the test code 25 (e.g., the functional test, reliability test, and performance test). The “AppID” represents the ID of the application 201 to which the test code 25 is applied. The “pre-check” represents the processing overview of the pre-check in execution of the test code 25. The “fault injection” and “measurement” represent the test process. The “fault injection” includes information on each of one or more fault injection items, and includes, for example, “resource type” representing the type of resources into which a failure is injected, “failure type” representing the type of a failure to be injected, and “test scenario” representing the scenario of the fault injection. The “measurement” includes measurements for the respective one or more measurement items. The “post-check” represents the processing overview of the post-check in execution of the test code 25. Data in the “pre-check”, “fault injection”, “measurement”, and “post-check” columns (columns indicated by a thick frame in FIG. 6) is an example of data that represents test-related attributes, and is used to generate one or more feature vectors 552. That is, the log analysis module 102 generates the one or more feature vectors 552 from the logs 551. The feature vectors 552 may be a structured dataset, and is used for clustering and generalization.

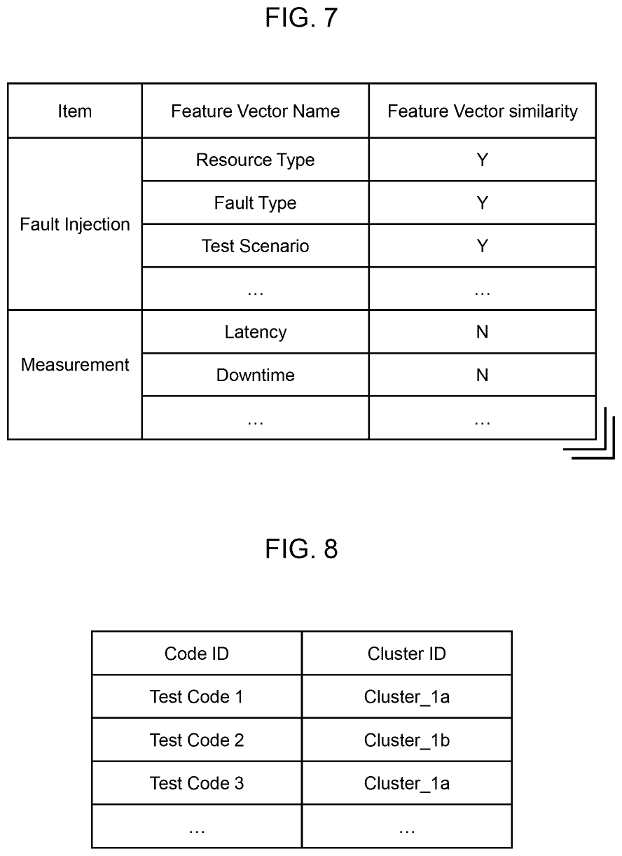

The clustering is performed (S503). In S503, the clustering module 103 classifies the test codes 25 into test code clusters, based on the one or more feature vectors 552 generated in S502. Each test code cluster is a set of one or more test codes 25 determined to be similar based on the one or more feature vectors 552. An example of similarity determination is as follows. Description is made with reference to FIG. 7. The clustering module 103 determines whether two test codes 25 constituting each test code pair are similar to each other or not with respect to the corresponding test code pair, using the feature vectors 552 of the two test codes 25. FIG. 7 shows similarity determination data that represents the similarity of the two test codes 25 with respect to each feature vector 552. The similarity determination data is generated for each test code pair. According to the similarity determination data exemplified in FIG. 7, for the two test codes 25, the resource type is similar, the failure type is similar, the test scenario is similar, the latency is not similar, and the downtime is not similar. With respect to each feature vector 552, an existing similarity determination method may be adopted for the similarity determination of the feature vectors 552 on the same attribute item. The similarity of two test codes 25 may be determination of whether the similarity ratio is equal to or higher than a predetermined value. The “similarity ratio” may be the ratio of N to M. M is the total number of attribute items of the feature vector 552. N is the number of attribute items corresponding to the feature vectors 552 determined to be similar. As described above, the test code cluster as a set of test codes 25 determined to be similar is constructed. The clustering module 103 associates each test code 25 with the cluster ID of the test code cluster to which the corresponding test code 25 belongs. For example, for each test code 25, the cluster classification data (see FIG. 8) that is data representing the relationship between the code ID and the cluster ID is output by the clustering module 103. The clustering module 103 may associate each test code 25 with all or some of the one or more feature vectors 552 corresponding to the test code 25 in addition to the cluster ID.

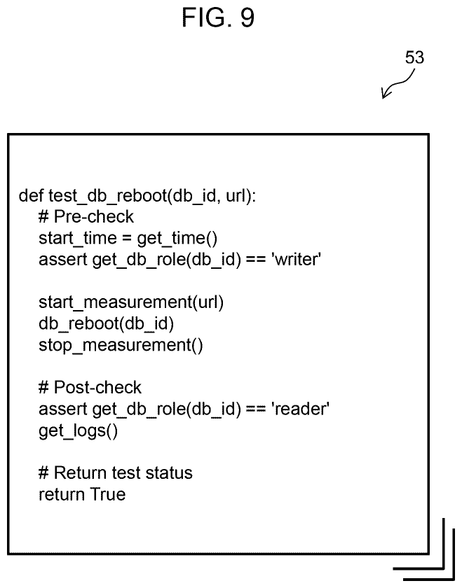

The code generalization is performed (S504). In S504, for each test code cluster, with respect to each similar test code set in the test code cluster, the generalization module 104 generates the generalized test code 25G from the similar test code set. To generate the generalized test code 25G, the code template corresponding to the similar test code set (e.g., the code template associated with the test content corresponding to the similar test code set) is used among the code templates included in the template set 553. An example of the code template is shown in FIG. 9. The code template is the template of the generalized test code 25G, and includes, for example, information that is abstraction target information after abstraction, such as information (e.g., the application ID) specific to the application 201. In the test code generalization, the information specific to the application 201 is abstracted, and the common logic is described in the similar test code set. Accordingly, the generalized test code 25G is reusable between different applications. Note that the template set 553 is stored in the storage apparatus 52. The template set 553 is managed by the template maintenance module 105. For example, in response to a request issued by the client computer 110, the template maintenance module 105 adds the code template to the template set 553, updates the code template in the template set 553, and removes the code template from the template set 553.

Test execution for the generated generalized test code 25G is performed (S505). In S505, for each test code cluster, the text execution module 101 executes the generalized test code 25G. A parameter value used to execute the generalized test code 25G may be a value determined by a predetermined method. For example, for the generalized test code 25G, the parameter value range may be defined, and a value selected from the range may be used as the parameter value. For each executed generalized test code 25G, one or more logs may be output. A test success or a test failure may be recorded as an execution result in any log.

If the execution result of any generalized test code 25G is the test failure, the code removal is performed (S506). In S506, the text execution module 101 removes the generalized test code 25G indicating the test failure, from the test code cluster that includes the generalized test code 25G. Subsequently, clustering is performed (S503). In the clustering, each test code 25 other than the one or more test codes 25 that correspond to the removed generalized test code 25G is classified into any test code cluster. That is, one or more new test code clusters are formed. For each new test code cluster, the code generalization is performed (S504), and the test execution is performed again (S505). If the generalized test code 25G indicating the test failure is present in the test execution, the generalized test code 25G is removed (S506), and the clustering is performed again.

As described above, the loop of clustering (S503)→code generalization (S504)→test execution (S505)→code removal (S505)→clustering (S503) is generated. The loop is continued until all the generalized test codes 25G achieve the test success, or the number of executed loops (or the loop duration) reaches the predefined number of retries (or retry time period).

If the execution results of all the generalized test codes 25G indicate the test success (or if the loop is finished), the code maintenance is performed (S507). In S507, the code maintenance module 106 adds the generalized test code 25G to the test code set 302 (see FIG. 3). As described above, the test code set 302 includes the individual test codes 25I and the generalized test code 25G in a mixed manner. Note that if the generalized test code 25G is added to the test code set 302, the individual test codes 25I corresponding to the generalized test code 25G may be removed from the test code set 302 by the code maintenance module 106. That is, the individual test codes 25I may be replaced with the generalized test code 25G.

By code generalization described with reference to FIG. 5 (S302), multiple (or one) test code clusters that each include one or more generalized test codes 25G are formed. In S303 in FIG. 3, for each test code cluster, the generalization module 104 causes the test code cluster to be the generalized test script 20G, based on, for example, the classification in S301 (the correspondence relationship between the test code and the test case). For example, the generalized test script 20G and the test case are associated with each other. Subsequently, in the association (S304), the generalized test script 20G is associated with the application 201.

The one example of the present invention has been described above. However, this is the example for describing the present invention. There is no intention to limit the scope of the present invention to the embodiment. The present invention can be executed as various other embodiments.

For example, the above description can be overviewed as follows. The following overview may include supplementary description, description of modified examples and the like.

The test code generation system (e.g., the test code generation system 100) that generates the test code for the cloud system (e.g., the cloud system 120), i.e., the cloud-based system, includes the test execution module (e.g., the text execution module 101), the log analysis module (e.g., the log analysis module 102), the clustering module (e.g., the clustering module 103), and the generalization module (e.g., the generalization module 104). The test execution module executes each of the test codes (e.g., the test codes 25), and outputs one or more logs (e.g., one or more logs 551). For each of the test codes, the log analysis module acquires one or more feature vectors (e.g., one or more feature vectors 552) from the one or more logs of each of the test codes. The clustering module classifies the test codes into a plurality of clusters (e.g., a plurality of test code clusters), based on the one or more feature vectors acquired from the one or more logs of each of the test codes. The generalization module generates a generalized test code (e.g., the generalized test code 25G) from the one or more test codes constituting each test code set in each of the clusters. Accordingly, the test script for the cloud-based system can be prevented from being redundant, and manual intervention can be reduced when the test script is applied. Specifically, for example, the test code generalization secures that the reusable test code can be utilized over the multiple applications in the cloud infrastructure. When a new application is deployed on the cloud system, the generalized test code can be applied to this application. Accordingly, the test consistent over the entire cloud system can be maintained. The cloud system includes specific applications, such as of distributed deployment, containerized service, or dynamic resource allocation. The aforementioned automated test code generation, and the generalized test code that is reusable between different applications can contribute to solving problems specific to the cloud system. The scalability, applicability, and efficiency of the test in the complicated cloud-based system can be improved.

In each of the clusters, the one or more test codes in the cluster may be a set of test codes determined to satisfy the first similarity requirement by the clustering module based on the one or more feature vectors with respect to each of the one or more test codes. For each test code set in the cluster, the one or more test codes constituting the test code set may be a set of test codes that satisfy the second similarity requirement in the cluster. Accordingly, the generated generalized test code is expected to be appropriate. Note that the example of the first similarity requirement may indicate that the similarity (e.g., the similarity ratio described above) is equal to or larger than a first threshold. On the other hand, a second similarity requirement may indicate that corresponding application components are common, or the similarity (e.g., the similarity ratio described above) is equal to or larger than a second threshold (note that the second threshold is larger than the first threshold).

With respect to each of the clusters, for each test code set in the cluster, a common logic among the one or more test codes constituting the test code set, and abstraction target information may be identified by referring to a code template, and the generalized test code that includes the identified common logic, and abstracted information obtained by abstracting the abstraction target information may be generated. Accordingly, the test code can be prevented from being redundant.

The test execution module may execute the generalized test code in the cluster. The test execution module may remove the generalized test code from the cluster if an execution result of the generalized test code indicates a test failure. This can reduce the possibility of a test failure in the cloud system. For example, reasons that the execution result of the generalized test code indicates a test failure include a possibility that the test code and clustering are not suitable for the test case to which the generalized test code belongs. According to such a possibility, the generalized test code having a possibility of a test failure even with being applied to the cloud system is not applied and removed. Consequently, a possibility of such a generalized test code adversely affects the actual test in the cloud system can be eliminated.

The loop including the following (A) to (C) may be repeated until the execution results of all the generalized test codes become the test success, or the number or duration of loops reaches a threshold. That is, the following may be performed. Accordingly, the cluster is made up of test codes other than the one or more generalized test codes corresponding to the generalized test code with the test failure.

Consequently, continuous improvement of the cluster can be realized. The test code that is applied to the cloud system is thus expected to be appropriate.
(A) The test execution module executes the generalized test code in the cluster.
(B) The test execution module determines if an execution result of the generalized test code indicates a test failure, or the number or a duration of loops undershoots a threshold.
(C) If the determination result of (B) is true, the test execution module removes the generalized test code from the cluster. The clustering module classifies the test codes other than the one or more test codes corresponding to the removed generalized test code, into clusters, based on the feature vectors of the test codes. The test execution module performs (A) for at least one of the clusters.

The code generation system may further include a control module. Each of applications deployed on the cloud system may include one or more application components. The control module may associate each of one or more generalized test scripts (e.g., one or more generalized test script 20G) that are test scripts each made up of one or more generalized test codes, with one or more applications each including an application component corresponding to the generalized test script. Accordingly, the generalized test script can be appropriately and automatically applied to the application in the cloud system.

1. A test code generation system generating test codes for a cloud system that is a cloud-based system, the test code generation system comprising:
a test execution module that executes each of the test codes, and outputs one or more logs, with respect to the corresponding test code;
a log analysis module that acquires one or more feature vectors from the one or more logs of each of the test codes;
a clustering module that classifies the test codes into a plurality of clusters, based on the one or more feature vectors acquired from the one or more logs of each of the test codes; and
a generalization module that generates a generalized test code from the one or more test codes constituting each test code set in each of the clusters.

2. The test code generation system according to claim 1, wherein with respect to each of the clusters,
the one or more test codes in the cluster constitute a set of test codes determined to satisfy a first similarity requirement by the clustering module, based on the one or more feature vectors for each of the one or more test codes, and
with respect to each test code set in the cluster, the one or more test codes constituting the test code set constitute a set of test codes that satisfy a second similarity requirement in the cluster.

3. The test code generation system according to claim 1, wherein with respect to each of the clusters, for each test code set in the cluster, the generalization module identifies a common logic among the one or more test codes constituting the test code set, and abstraction target information, by referring to a code template, and generates the generalized test code that includes the identified common logic, and abstracted information obtained by abstracting the abstraction target information.

4. The test code generation system according to claim 1, wherein the test execution module:
executes the generalized test code in the cluster; and
removes the generalized test code from the cluster if an execution result of the generalized test code indicates a test failure.

5. The test code generation system according to claim 1, wherein
(A) the test execution module executes the generalized test code in the cluster,
(B) the test execution module determines if an execution result of the generalized test code indicates a test failure, or the number or a duration of loops from (A) to (C) undershoots a threshold, and
(C) if a determination result of (B) is true, the test execution module removes the generalized test code from the cluster, the clustering module classifies test codes other than the one or more test codes corresponding to the removed generalized test code, into a plurality of clusters, based on the feature vectors of the test codes, and the test execution module performs (A) for at least one of the clusters.

6. The test code generation system according to claim 1, further comprising a control module, wherein
each of applications deployed on the cloud system includes one or more application components, and
the control module associates each of one or more generalized test scripts that are test scripts each made up of one or more generalized test codes, with one or more applications each including an application component corresponding to the generalized test script.

7. A test code generation method of generating test codes for a cloud system that is a cloud-based system, the test code generation method causing a computer to execute:
executing each of the test codes, and outputting one or more logs, with respect to the corresponding test code;
acquiring one or more feature vectors from the one or more logs of each of the test codes;
classifying the test codes into a plurality of clusters, based on the one or more feature vectors acquired from the one or more logs of each of the test codes; and
generating a generalized test code from the one or more test codes constituting each test code set in each of the clusters.
